(19) United States
(12) Patent Application Publication
(10) Pub. No.: US 2013/0068247 A1
(43) Pub. Date: Mar. 21, 2013

(54) METHODS AND APPARATUS FOR CLEANING SURGICAL INSTRUMENTS

(71) Applicants: Kester J. BATCHELOR, Minneapolis, MN (US); Tracey L. DOBBS, Delano, MN (US); Jyue Boon LIM, New Brighton, MN (US); Nikhil M. MURDESHWAR, Maple Grove, MN (US); Tsuyoshi HAYASHIDA, Maple Grove, MN (US)

(72) Inventors: Kester J. BATCHELOR, Minneapolis, MN (US); Tracey L. DOBBS, Delano, MN (US); Jyue Boon LIM, New Brighton, MN (US); Nikhil M. MURDESHWAR, Maple Grove, MN (US); Tsuyoshi HAYASHIDA, Maple Grove, MN (US)

(73) Assignee: GYRUS MEDICAL, INC., Maple Grove, MN (US)

(21) Appl. No.: 13/237,109

(22) Filed: Sep. 20, 2011

(51) Int. Cl. B08B 3/12

(52) U.S. Cl. 134/1; 134/184

(57) ABSTRACT

Methods and apparatus for cleaning a surgical instrument during a surgical procedure insert at least the portion of the surgical instrument that is to be cleaned into a vessel containing a liquid and applying ultrasonic vibrations to the liquid within the vessel to generate cavitation bubbles in the liquid. The bubbles formed by cavitation of the liquid are very effective at removing debris from the surgical instrument, particularly from crevices and difficult-to-reach areas of the surgical instrument. The liquid also can be heated by a heating element of the vessel or by activating a heat-generating transducer of the surgical instrument being cleaned, or both.

### BACKGROUND

The present disclosure relates to methods and apparatus for cleaning surgical instruments, and particularly to methods and apparatus for use in cleaning surgical instruments during a surgical procedure.

Many surgeons desire to clean surgical instruments during the course of a surgical procedure, for example, because debris that hinders optimal use of the surgical instrument becomes adhered to the surgical instrument during the surgical procedure. This situation is common in surgical instruments that generate thermal energy (for example, it is a cauterizing surgical instrument) because debris from the surgical site tends to become adhered onto the surgical instrument. Such debris tends to be insulative, and can prevent the surgical instrument from operating properly particularly when the instrument applies an electric potential between two electrodes to cause the heating. For example, Radio Frequency (RF) products used in electrosurgical procedures tend to suffer from adhesion of tissue and other matter through the course of a surgical procedure due to bringing such a device, which becomes heated, into contact with protein and other materials that change state when exposed to heat.

Accordingly, many surgeons typically will clean the surgical instrument one or more times (often 3-8 times) during the surgical procedure. For example, the surgical instrument could be wiped with a sterile cloth that has been wetted with saline solution. Sometimes a brush or scrubbing pad is used to clean the surgical instrument. However, many surgical instruments have crevices and other difficult-to-reach recesses that are not cleaned well by wiping, brushes or scrubbing pads. U.S. Patent Application Publication No. US2002/0022762 A1 discloses a device that can be used to clean and heat the lens of an optical surgical instrument (such as an endoscope) with a wetted sponge or pad.

### SUMMARY

In accordance with at least some aspects of the invention, methods and apparatus for cleaning a surgical instrument during a surgical procedure insert at least a portion of the surgical instrument that is to be cleaned into a vessel containing a liquid and apply ultrasonic vibrations to the liquid within the vessel to generate cavitation bubbles in the liquid. The bubbles formed by cavitation of the liquid are very effective at removing debris from the surgical instrument, particularly from crevices and difficult-to-reach areas of the surgical instrument. After applying the ultrasonic vibrations to the liquid to remove the debris from the surgical instrument, the surgical instrument is reinserted into the body of the patient.

The vessel can include an ultrasonic transducer that is activated to apply the ultrasonic vibrations to the liquid within the vessel. According to some embodiments, the ultrasonic transducer is powered by a main power supply. According to other embodiments, when the surgical instrument itself uses an ultrasonic transducer, the ultrasonic transducer of the vessel can be powered by the power supply that is used to power the instrument ultrasonic transducer. Such an arrangement simplifies the structure of the vessel because the ultrasonic transducer included with the vessel does not require its own ultrasonic transducer driving unit, but instead can use the ultrasonic transducer driving unit that is used with the surgical instrument.

According to some embodiments, when the surgical instrument is an ultrasonic surgical instrument that is detachably coupleable to a handpiece that includes an instrument ultrasonic transducer, the vessel can be attached to the handpiece and thus use the instrument ultrasonic transducer to apply the ultrasonic vibrations to the liquid within the vessel.

The cleaning effect can be further enhanced by heating the liquid within the vessel during the cleaning. In accordance with some embodiments, the vessel includes a heating element that heats the liquid within the vessel. The heating element can be powered by a main power supply or, if the surgical instrument includes a power supply, the power supply of the surgical instrument can be attached to the vessel to power the heating element. A temperature control circuit can be included to prevent the vessel liquid from overheating.

According to some embodiments, when the surgical instrument includes an electrically-operated heating transducer, the electrically-operated heating transducer of the surgical instrument can be powered while the surgical instrument is placed within the vessel filled with liquid so as to heat the liquid in the vessel and thus enhance the cleaning effect. Furthermore, powering the electrically-operated heating transducer of the surgical instrument while it is disposed within the vessel causes gas (steam) bubbles to be generated at the surface of the surgical instrument, which further assists in removing debris from the surgical instrument.

According to some embodiments, the vessel includes a seal member that seals an open end of the vessel. The seal member includes a slot or hole through which the end of the surgical instrument that is to be cleaned is inserted. The seal member inhibits the liquid from splashing out of the vessel, particularly when the ultrasonic transducer is operating to generate cavitation bubbles within the liquid in the vessel.

Preferably, the vessel includes an insert into which the liquid is placed and an outer portion into which the insert is inserted. The outer portion insulates/decouples the ultrasonic vibrations that are generated within the insert so that the user holding the vessel does not feel the vibrations. According to some embodiments, the insert could be a removable glass insert that could be sterilized or discarded after each surgical procedure, whereas the outer portion could be made from stainless steel and is reusable. The vessel preferably is transparent, and according to some embodiments the outer portion, when provided, preferably also is transparent so that the user can view the surgical instrument and monitor the progress of the cleaning process.

According to some embodiments, the vessel includes an open end through which the surgical instrument is inserted into the liquid in the vessel, and the vessel has no further openings other than the open end.

According to some embodiments, the vessel includes an open end through which the surgical instrument is inserted into the liquid in the vessel, and the vessel has a length extending in a first direction that intersects the open end and that is parallel to an insertion direction by which the surgical instrument is inserted into the vessel through the open end, the vessel has a width extending in a second direction perpendicular to the first direction, and the length is substantially greater than the width.

### BRIEF DESCRIPTION OF THE DRAWINGS

Exemplary embodiments of the invention will be described with reference to the drawings in which like reference numerals refer to like elements, and in which:

FIG. 1 is a high-level drawing of surgical instruments and a cleaning device that can be used to clean the surgical instruments;

FIG. 2 is a side sectional view of a cleaning device according to a first embodiment;

FIG. 3 is a side sectional view of a cleaning device according to a second embodiment;

FIG. 4 is a side sectional view of a cleaning device according to a third embodiment;

FIG. 5 is a side sectional view of a cleaning device according to a fourth embodiment;

FIG. 6 is a side sectional view of a cleaning device according to a fifth embodiment;

FIG. 7 is a side sectional view of a cleaning device according to a sixth embodiment;

FIG. 8 is a diagram of a cleaning device including a heating element control circuit;

FIG. 9 shows a cleaning device having a reusable outer portion and a single-use liquid-holding vial;

FIG. 10 shows a seal member that can be used with the cleaning devices; and

FIG. 11 shows a cleaning device that includes protruding bristles on the internal surface of the cleaning device.

### DETAILED DESCRIPTION OF EMBODIMENTS

Numerous embodiments of the invention will be described in connection with cleaning various surgical instruments. Some of the embodiments will be described in conjunction with surgical instruments that apply ultrasonic vibrations (to incise tissue) and radio frequency (RF) energy (to perform hemostasis/coagulation). However, the invention is not limited to use with only those types of surgical instruments. The various embodiments can be used with numerous types of surgical instruments, and are particularly suited for surgical instruments that require cleaning during their use in a surgical procedure. For example, embodiments of the invention can be used with endoscopes, laparoscopes, RF (high frequency) energy applying surgical instruments, scalpels, etc.

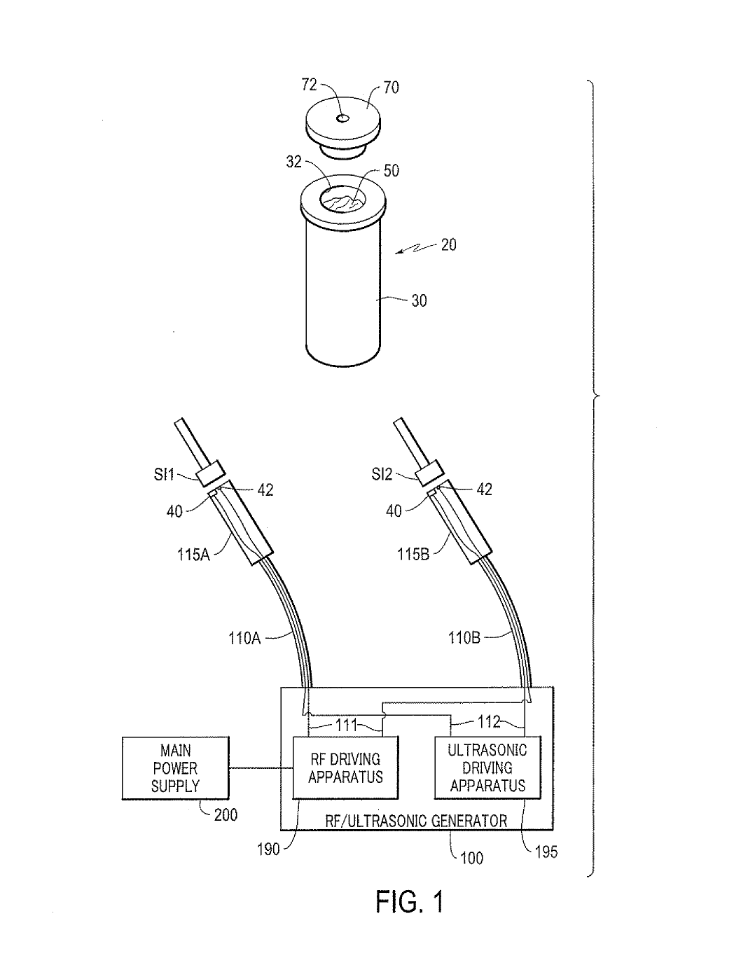

FIG. 1 is a high-level drawing of surgical instruments that apply ultrasonic vibrations and RF energy to a patient, and a cleaning device that can be used with such instruments. The exemplary surgical instrument is used to perform surgical procedures in which bodily tissue and/or vessels are incised and cauterization is performed.

In FIG. 1, the surgical instrument is used in conjunction with an RF/ultrasonic generator 100 that can power multiple surgical instruments SI1 and SI2. The generator 100 can include couplings for use with more than two surgical instruments. The generator 100 is coupled to a main power supply 200 from which electrical power to operate the surgical instruments is obtained. The generator 100 includes various control circuits that are known in the art and that output signals appropriate for operating the RF portion of each surgical instrument and the ultrasonic portions of each surgical instrument. In particular, generator 100 includes an RF (or high frequency) driving apparatus 190 and an ultrasonic driving apparatus 195. The RF driving apparatus 190 is a high-frequency power supply unit that supplies current to the surgical instruments via current lines 111. The ultrasonic driving apparatus 195 is an ultrasonic power supply unit that supplies electric power to surgical units via electric power lines 112. Each of the surgical instruments SI1 and SI2 has a distal end that can be ultrasonically vibrated to incise and/or liquefy tissue (depending on the structure of the distal end). The distal end of each surgical instrument also is electrically conductive and functions as an electrode when current is supplied to it via its current line 111 so as to perform electric cautery. One example of a surgical instrument that applies ultrasonic vibrations and high-frequency energy is disclosed in U.S. Pat. No. 7,922,651 B2, the disclosure of which is incorporated herein by reference in its entirety. If the surgical instrument is a bipolar (or tripolar) device, it includes its own built-in counter-electrode for completing the electric cautery circuit as is known in the art. If the surgical instrument is monopolar, then a separate counter-electrode plate is attached to the patient to complete the electric cautery circuit.

The RF/ultrasonic generator 100 in FIG. 1 includes first and second supply lines 110a and 110b, which are detachably coupled to corresponding first and second handpieces 115a and 115b. The supply lines 110a and 110b include lines 111 and 112 that respectively supply appropriately controlled electrical signals for the RF portion of the surgical instrument and for the ultrasonic portion of the instrument. The first handpiece 115a can be detachably coupled to a first surgical instrument SI1, whereas the second handpiece 115b can be detachably coupled to a second surgical instrument SI2. The distal end of each handpiece 115a, 115b that detachably couples to the corresponding surgical instrument includes at least three parts. The first part is a mechanical coupling enabling the handpiece to physically connect to and lock with the surgical instrument. The second part is an electrical connector 42 so that the appropriately controlled signal on line 111 for the RF portion of the surgical instrument is supplied to a corresponding electrical connector in the coupling portion of the surgical instrument. When the handpiece is connected to the surgical instrument, the appropriately controlled signal for controlling the RF portion (transducer) of the surgical instrument is supplied to the surgical instrument. Thus, when the operator holding the handpiece attached to the surgical instrument actuates the RF transducer, the transducer which is located near the distal end of the surgical instrument will conduct current, for example, between two jaws of the surgical instrument to thereby generate heat that is used during the surgical procedure to achieve hemostasis of the portion of the patient being acted on by the surgical instrument. The third portion is a piezoelectric transducer 40 that is disposed in the handpiece where the handpiece attaches to the surgical instrument. When attached to the surgical instrument and activated, the piezoelectric transducer 40 will generate ultrasonic vibrations that are then transmitted through the surgical instrument to the distal end of the surgical instrument.

A cleaning device 20, to be described in more detail below, can be used by the surgeon during the surgical procedure to clean the distal end of the surgical instrument. When the surgeon believes that the surgical instrument should be cleaned during the surgical procedure, the surgical instrument is (i) removed from the body of the patient, (ii) inserted into the cleaning device and cleaned (to be described in more detail below), and then (iii) reinserted into the body of the patient after cleaning so that the surgical procedure can be resumed. According to one embodiment, the cleaning device 20 includes a water-proof vessel 30 having an opening 32 at one end. No further opening other than the opening 32 is provided in the vessel. The vessel 30 is filled with a non-flammable liquid 50 such as saline or ringers lactate. The vessel 30 includes an opening 32 into which the distal end of the surgical instrument is inserted. According to some embodiments, a seal member 70 can be used to seal the opening 32 of the vessel. The seal member 70 includes a slit or hole (opening) 72 therein and through which the distal end of the surgical instrument can be inserted. The seal member 70 thus seals around the inserted surgical instrument. The seal member 70 prevents the liquid 50 from splashing out of the vessel 30 during the cleaning operation during which the ultrasonic vibrations are applied to the liquid 50.

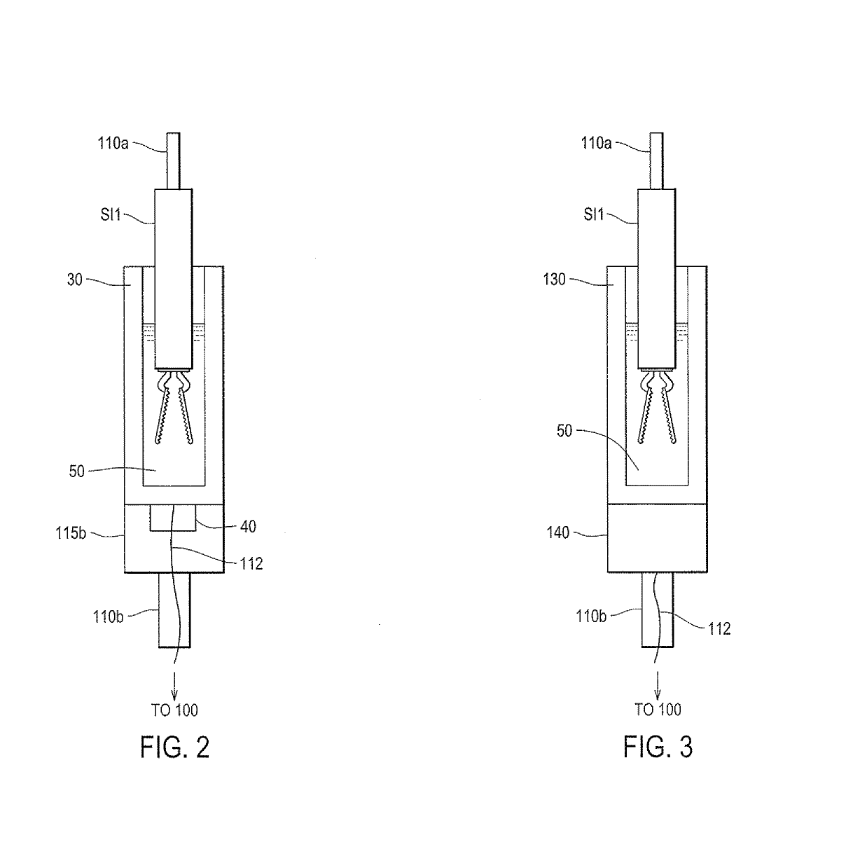

FIG. 2 is a side sectional view of a cleaning device according to a first embodiment. The seal member 70 is omitted to simplify the drawing. The cleaning device in FIG. 2 includes a vessel 30 filled with cleaning liquid 50 such as saline or ringers lactate. In the FIG. 2 embodiment, the piezoelectric transducer 40 contained in the surgical instrument handpiece 115h is used to ultrasonically vibrate the cleaning liquid 50 to cause cavitation bubbles in the liquid 50. As shown in FIG. 2, the handpiece 115b is attached to the closed end of the vessel 30 such that the piezoelectric transducer 40 in the handpiece 115b is coupled to the vessel 30. The supply line 110b associated with handpiece 115b supplies appropriately controlled signals along line 112 from the ultrasonic driving apparatus 195 of the RF ultrasonic generator 100 to the handpiece 115b so as to activate the piezoelectric transducer 40 (the RF/signal from generator 100 is not used with handpiece 115b). By inserting a surgical instrument, such as surgical instrument SI1 into the vessel 30 and then activating the piezoelectric transducer 40 in the handpiece 115b (the handpiece for a different surgical instrument SI2), ultrasonic vibrations are induced in the liquid 50. This causes cavitation bubbles to be generated in the liquid 50 which clean the portion of the surgical instrument SI1 disposed within the liquid 50. After cleaning the surgical instrument, the surgical instrument is reinserted into the body of the patient and the surgical procedure is resumed.

In order to further improve the cleaning effect, the RF transducer of the surgical instrument SI1 can be activated in order to heat the liquid adjacent to the distal end (sometimes called the jaws) of the surgical instrument SI1. This causes steam bubbles to be generated at the location of the jaws, further assisting in the removal of debris from the jaws. In this embodiment, the surgical instrument SI1 that is to be cleaned is placed into the vessel 30 while it remains connected to the generator 100 (the handpiece 115a is not shown in FIG. 2 in order to simplify the drawing). The RF control signal is supplied from RF driving apparatus 190 of generator 100 along line 111 to the surgical instrument SI1 through the supply tube 110a and handpiece 115a. The user observes the condition of the liquid 50 in the vessel 30 and can shut off power to the instrument SI1 to ensure that the liquid 50 does not over-heat.

If the surgical instrument SI is a bipolar instrument and the liquid is a non-flammable electrically conductive liquid such as saline or ringers lactate, then simply turning on the RF portion of the surgical instrument SI1 will cause current to flow between the poles of the surgical instrument and thus cause the heating effect. If the surgical instrument SI1 is a monopolar device, then a grounded electrode is included within the vessel 30 such that current will flow from the pole of the surgical instrument SI1 to the grounded electrode, thereby generating heat.

FIG. 3 is a side sectional view of a cleaning device according to a second embodiment. The FIG. 3 cleaning device is similar to the FIG. 2 cleaning device except that the vessel 130 includes an ultrasonic transducer 140 attached to the vessel 130. That is, the cleaning device includes its own built-in ultrasonic transducer 140. In the FIG. 3 embodiment, the ultrasonic transducer can be a piezoelectric transducer. In the FIG. 3 embodiment, the control signal for use with the ultrasonic transducer 140 is provided from the ultrasonic driving apparatus 195 of the RF/ultrasonic generator 100. Accordingly, the ultrasonic transducer 140 is detachably coupled to the supply line 110b (containing line 112) associated with the generator 100. Because the generator 100 has its own ultrasonic generator control circuit (i.e., ultrasonic driving apparatus 195), the signal supplied from the generator 100 is appropriately modulated for operating the piezoelectric transducer 140 so as to generate ultrasonic vibrations. The signal is modulated to cause the piezoelectric transducer to vibrate at 20-40 kHz, but the device could use a higher or lower frequency to achieve the cleaning effect. It is understood that ultrasonic cleaning works best within the 20-40 kHz range and even more preferably within the 30-40 kHz range. 40 kHz is most preferable as it is considered to be the optimal frequency for generating sufficiently small cavitation bubbles which are better suited for fine detail cleaning for devices such as the tips and jaws of electrosurgical devices.

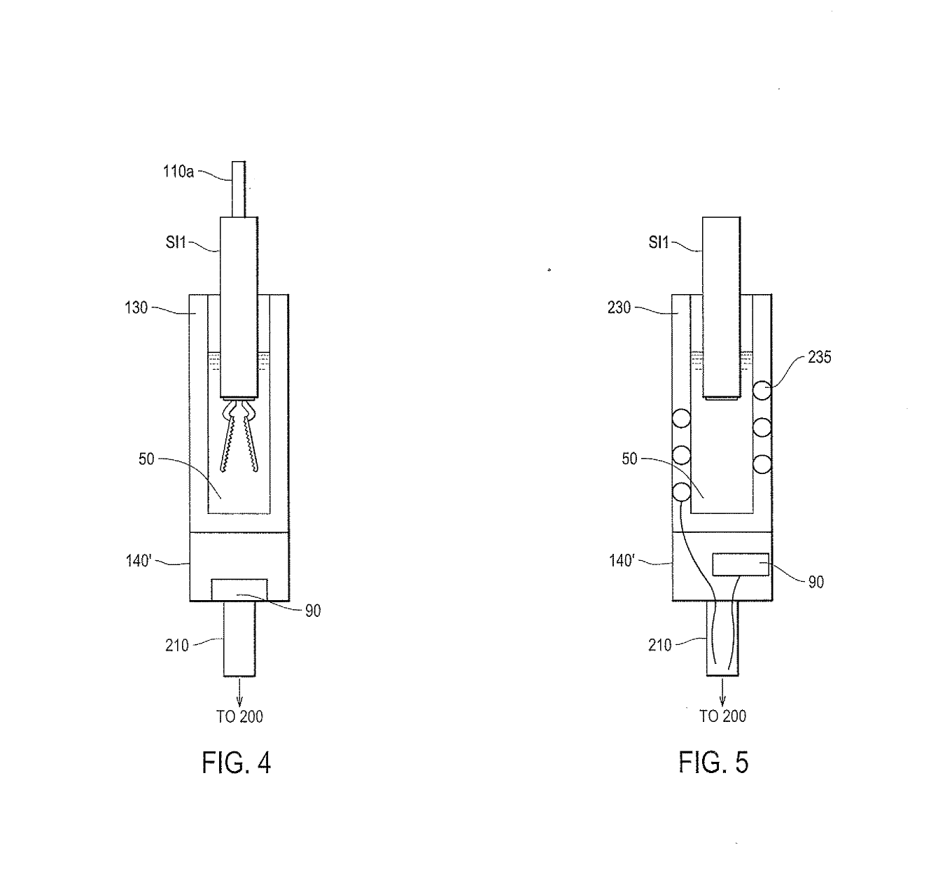

FIG. 4 is a side sectional view of a third embodiment. The third embodiment is similar to the second embodiment except that the ultrasonic transducer 140′ of the third embodiment includes its own internal ultrasonic transducer driving apparatus (control circuit) 90. Thus, the cleaning device of the third embodiment can be supplied with power from a power cord 210 that attaches to the main power source 200. Current supplied through power line 210 is appropriately modulated (as described above) by control circuit 90 so as to operate the piezoelectric transducer of transducer 140′ to generate ultrasonic vibrations and cavitation bubbles within the liquid 50 inside of vessel 130.

The embodiments shown in FIGS. 2-4 can be used to clean any type of surgical instrument. With respect to the embodiments of FIGS. 2-4, the liquid 50 within the cleaning device can be heated if the surgical instrument that is being cleaned includes its own heat-generating element. For example, the embodiments of FIGS. 3 and 4 also could heat the liquid by activating the RF transducer of the surgical instrument SI1 as described with respect to the FIG. 2 embodiment. The embodiments of FIGS. 3 and 4 also could include a grounded electrode for heating the liquid when used with a monopolar electrosurgical instrument. Preferably the vessel 30/130 in the embodiments of FIGS. 2-4 is transparent so that the user can view the surgical instrument and monitor the progress of the cleaning process.

The embodiments illustrated in FIGS. 5-7 are similar to the first three embodiments, except that the vessel includes its own internal heating element (235 or 335). Accordingly, the embodiments illustrated in FIGS. 5-7 can apply heat to the liquid even when the surgical instrument SI to be cleaned does not itself generate heat. However, the cleaning device of FIGS. 5-7 could apply heat with heating element 235/335 and activate the heating transducer of the surgical instrument (e.g., SI1 or SI2) to further generate steam bubbles at the tip of the surgical instrument to further enhance cleaning. Like the embodiments of FIGS. 2-4, preferably the vessel 230/330/430 in the embodiments of FIGS. 5-7 is transparent so that the user can view the surgical instrument and monitor the progress of the cleaning process.

FIG. 5 is a side sectional view of a cleaning device having its own built-in heating element 235. The FIG. 5 embodiment is very similar to the FIG. 4 embodiment except for the inclusion of the heating element 235. The heating element 235 is supplied with power from the main power supply 200. The device preferably includes a heating control circuit (to be described later) so that the liquid 50 is not over-heated. While FIG. 5 shows the heating element 235 in the container that holds the liquid 50, the heating element 235 alternatively could be located in an outer portion of the vessel into which a removable liquid-holding insert is inserted.

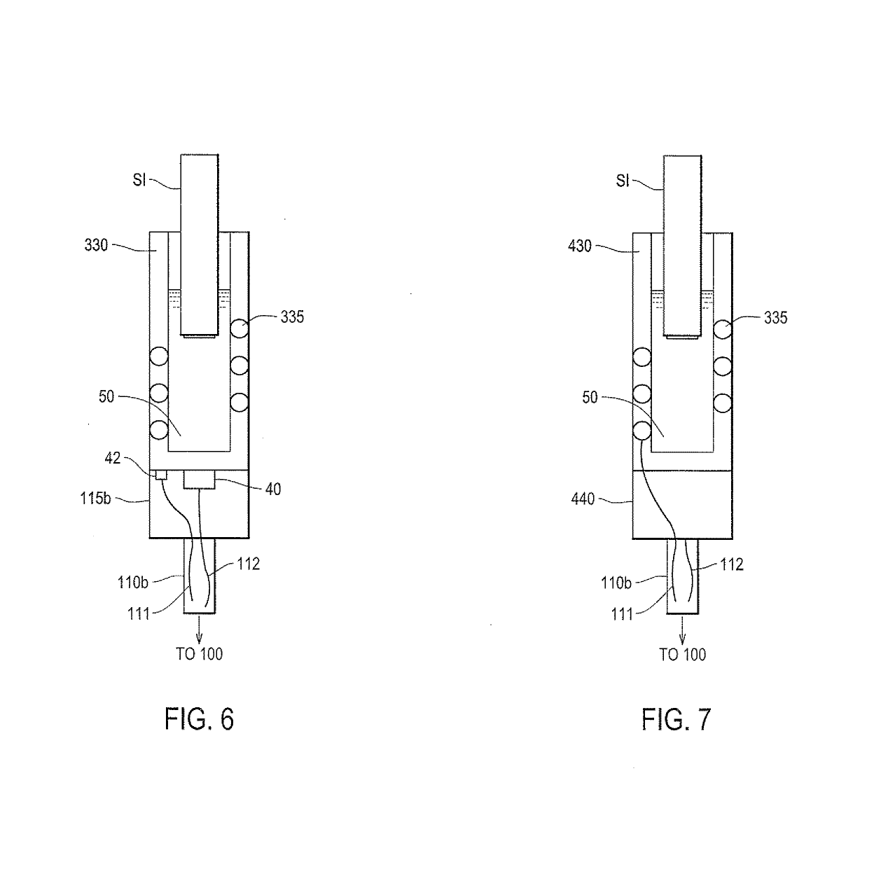

FIG. 6 is a side sectional view of another cleaning device having its own built-in heating element 335. The FIG. 6 embodiment is similar to the FIG. 2 embodiment except for the inclusion of the heating element 335 and an electrical connector that electrically connects to an electrical connector 42 on the handpiece 115b so that the control signal conveyed by current line 111 from the RF driving apparatus 190 of generator 100 is supplied to the heating element 335. The FIG. 6 embodiment also preferably includes a heating control circuit (to be described later) so that the liquid 50 is not over-heated. The heating element 335 can be provided in the container that holds the liquid (as shown) or in an outer portion of the vessel into which a liquid-holding insert is removably placed.

FIG. 7 is a side sectional view of a cleaning device having its own built-in heating element 335. The FIG. 7 embodiment is similar to the FIG. 3 embodiment except for the inclusion of the heating element 335 and an electrical connector that electrically connects to the current line 111 of the supply line 110b to supply a control signal to the heating element 335. Like the embodiment of FIGS. 5 and 6, the FIG. 7 embodiment preferably includes a heating element control circuit so that the liquid is not overheated, and the heating element 335 can be disposed in the liquid-holding container or in an outer portion of the vessel into which a liquid-holding insert is removably placed.

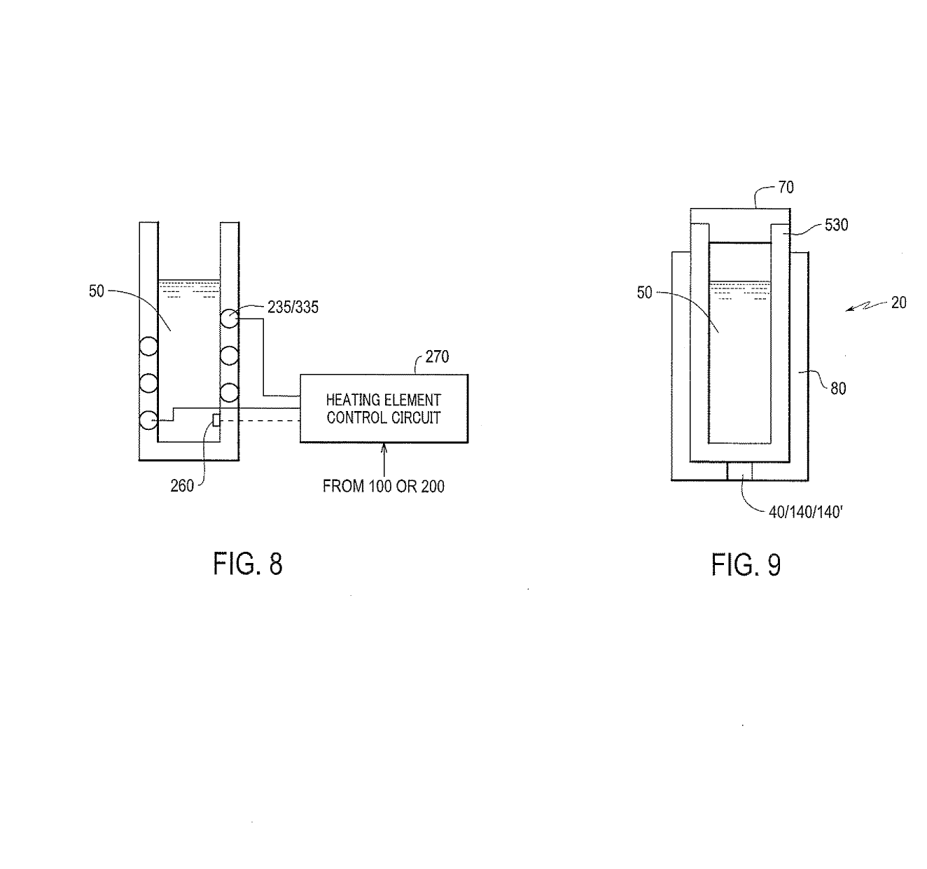

FIG. 8 is a diagram showing a heating element control circuit 270 that can be included in any of the embodiments of FIGS. 5-7. The heating element control circuit 270 receives electrical power from generator 100 or main power supply 200 and controllably supplies that power to the heating element 235 or 335 to heat the liquid 50 in the vessel. The vessel includes a temperature sensor 260 coupled to the heating element control circuit 270. The control circuit 270 controls the supply of current to the heating element 235/335 based on the temperature sensed by sensor 260 to prevent the liquid 50 from becoming overheated. The optimal temperature for the liquid 50 depends on the type of material (debris) that is being cleaned from the surgical instrument.

FIG. 9 is a diagram showing embodiments of the cleaning device in which an outer portion 80 of the vessel removably holds an insert which holds the cleaning liquid. The insert can be, for example, a glass vial 530 having a seal member 70 that covers its closed end. The outer portion 80 can be made from stainless steel, plastic or other materials and removably holds the glass vial 530. The outer portion could be held in one hand by the user while cleaning a surgical instrument and will dampen the transmission of (decouple the) vibrations from the piezoelectric transducer 40/140/140′ to the user. The outer portion 80 could have a built-in piezoelectric transducer 140/140′, or could include an opening to receive the piezoelectric transducer 40 from one of the surgical instrument handpieces 115a, 115b. The outer portion also could include heating elements 235/335. The outer portion 80 could be supplied with a plurality of glass vials 530 so that each vial is used during a single surgical procedure (although the vial could be used multiple times to perform multiple cleanings during that single surgical procedure) and then discarded. The outer portion could be used for multiple surgical procedures. The vial preferably is transparent, and according to some embodiments the outer portion, when provided, preferably also is transparent so that the user can view the surgical instrument and monitor the progress of the cleaning process.

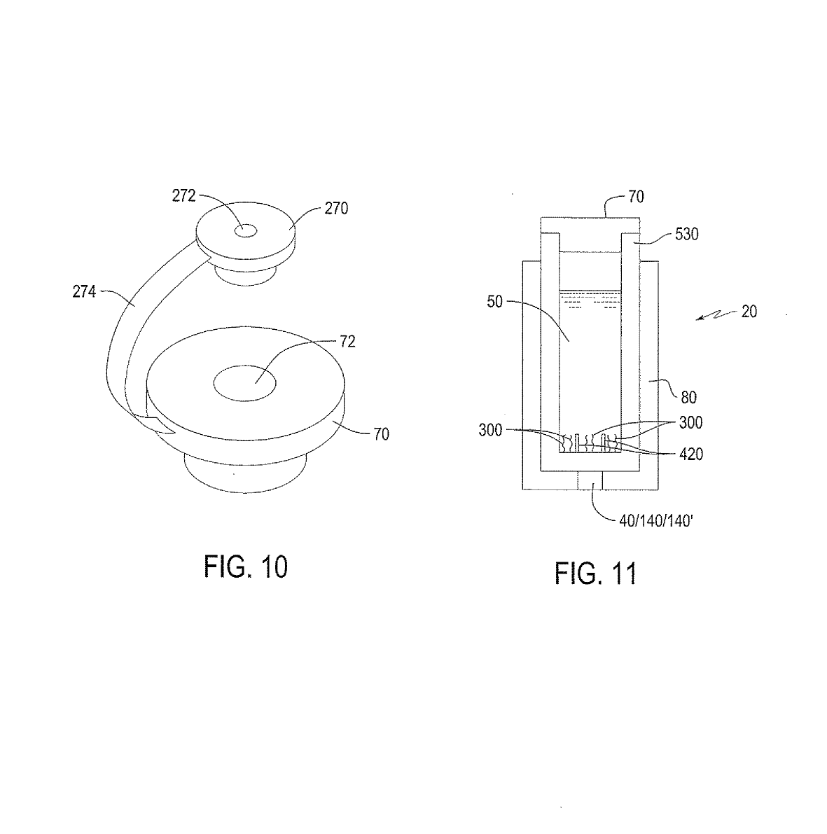

FIG. 10 shows one embodiment of the seal member 70 that can be used to seal the open end of the vessel of the cleaning device. The seal member 70 is made from an elastomeric material and removably closes (plugs) the open end of the vessel. The seal member 70 includes a compliant opening 72 (a slit or hole) that seals around the surgical instrument when the surgical instrument is inserted through the opening. The size of the opening can vary depending on the diameter of the surgical instrument to be cleaned. According to one embodiment, shown in FIG. 10, the opening 72 is designed to receive a 10-15 mm diameter shaft and includes an adapter 270 having a smaller opening 272 that is designed to receive a 3-6 mm shaft. The adapter 270 is tethered to the seal member 70 by a strap 274, although it could be a separate member. The elastomeric seal member 70/270 only needs to be strong enough to withstand being penetrated by the surgical instrument 5-10 times.

FIG. 11 is a diagram showing embodiments of the cleaning device similar to FIG. 9, except that bristles 300 are included on at least part of the internal surface of the liquid-containing portion of the cleaning device. Although FIG. 11 shows the bristles 300 on only the lower (bottom) surface of the vial 530, bristles 300 could be provided on the side surface of the vial in addition to, or instead of, on the lower surface of the vial. The bristles 300 are flexible and protrude inwardly into the liquid 50 within the vial. When the vibrations are generated by the piezoelectric transducer 40/140/140′, the bristles also will be vibrated to further increase the cavitation effect and generation of cleaning bubbles within the liquid 50. In addition, the bristles can be sufficiently long so as to contact surfaces of the surgical instrument within the vial 530 so as to perform a mechanical cleaning of the surgical instrument when the bristles 300 are vibrated. The remaining components in FIG. 11 are similar to those in FIG. 9 and thus are not described again. The bristles 300 can be included in any of the embodiments previously described (that is, with respect to FIGS. 2-9). FIG. 11 also shows a plurality of energy directors 420 that can be provided within the vessel (or vial). Preferably at least one energy director 420 is provided. Each energy director 420 is a structure that will vibrate when subjected to the ultrasonic vibrations created by the piezoelectric transducer, thereby increasing the cavitation bubbles that are generated within the vessel or vial. According to one example, each energy director 420 is a metal bar that is tuned (has a thickness, length and stiffness) such that it will oscillate when subjected to the ultrasonic vibrations created by the piezoelectric transducer. One or more of the energy directors 420 can be included in any of the embodiments previously described (that is, with respect to FIGS. 2-9).

Aspects regarding the shape of the liquid-containing vessel also are shown in FIG. 11. The vessel has a length L extending in a first direction (vertical direction in FIG. 11) that intersects the open end of the vessel and that is parallel to an insertion direction. (up-and-down direction in FIG. 11) by which the surgical instrument is inserted into the vessel through the open end. The vessel also has a width W extending in a second direction (horizontal direction in FIG. 11) perpendicular to the first direction. In particular, the length L is substantially greater than the width W. For example, the length L is at least twice as great as the width W. Preferably the length L is 2 to 20 times greater than the width W. Typical dimensions for the length L are 150 mm, and typical dimensions for the width W are 22 mm, although these dimensions are merely examples. Of course, the size of the vessel might depend on the size of the surgical instrument that is to be cleaned; however, the length L usually will be at least twice as great as the width W.

While the invention has been described with reference to preferred embodiments thereof, it is to be understood that the invention is not limited to the preferred embodiments or constructions. The invention is intended to cover various modifications and equivalent arrangements. In addition, while the various elements of the preferred embodiments are shown in various combinations and configurations, that are exemplary, other combinations and configurations, including more, less or only a single element, are also within the spirit and scope of the invention.

What is claimed is:

1. A method of cleaning a surgical instrument during a surgical procedure, the method comprising:
removing the surgical instrument from a body of a patient undergoing the surgical procedure;
inserting at least a portion of the surgical instrument into a vessel that contains a liquid;
applying ultrasonic vibrations to the liquid within the vessel to generate cavitation bubbles in the liquid to remove debris from the surgical instrument; and
after the step of applying ultrasonic vibrations to the liquid to remove the debris from the surgical instrument, reinserting the surgical instrument into the body of the patient.

2. The method of claim 1, wherein the vessel includes an ultrasonic transducer that is activated to apply the ultrasonic vibrations to the liquid within the vessel.

3. The method of claim 2, wherein the surgical instrument includes an instrument ultrasonic transducer, and wherein the method includes powering the ultrasonic transducer of the vessel with power from a power supply that is used to power the instrument ultrasonic transducer.

4. The method of claim 2, wherein the method includes powering the ultrasonic transducer of the vessel with power from a main power supply.

5. The method of claim 1, wherein the surgical instrument is an ultrasonic surgical instrument that is detachably coupleable to a handpiece that includes an instrument ultrasonic transducer that generates ultrasonic vibrations in the ultrasonic surgical instrument, and wherein the method includes applying the ultrasonic vibrations to the liquid within the vessel by attaching the handpiece of the surgical instrument to the vessel and activating the instrument ultrasonic transducer of the handpiece.

6. The method of claim 1, further comprising heating the liquid in the vessel during the cleaning.

7. The method of claim 6, wherein the vessel includes a heating element that heats the liquid within the vessel.

8. The method of claim 7, wherein the surgical instrument includes an electrically-operated transducer, and wherein the method includes powering the heating element of the vessel with power from a power supply that is used to power the electrically-operated transducer of the surgical instrument.

9. The method of claim 7, wherein the method includes powering the heating element of the vessel with power from a main power supply.

10. The method of claim 6, wherein the surgical instrument includes an electrically-operated heat generator, and wherein the liquid in the vessel is heated by activating the electrically-operated heat generator of the surgical instrument while the surgical instrument is inserted into the vessel.

11. The method of claim 1, wherein the surgical instrument includes an electrically-operated heat generator, the method further comprising:
activating the electrically-operated heat generator of the surgical instrument while the surgical instrument is inserted into the vessel.

12. The method of claim 1, wherein the vessel has an open end that is sealed by a seal member, and wherein the inserting step includes inserting at least the portion of the surgical instrument through an opening in the seal member, the seal member inhibiting the liquid from leaking from the vessel.

13. The method of claim 6, wherein a temperature of the liquid is monitored, and the heating of the liquid is controlled based on the monitored temperature of the liquid.

14. The method of claim 1, wherein a plurality of bristles are provided on an internal surface of the vessel.

15. The method of claim 1, wherein at least one energy director is provided on an internal surface of the vessel.

16. A surgical instrument cleaning apparatus comprising:
a liquid-proof vessel configured to hold a liquid while receiving at least a portion of a surgical instrument that is to be cleaned, the vessel including an open end through which the surgical instrument is inserted into the liquid in the vessel, the vessel having no further openings other than the open end; and
an ultrasonic transducer coupled to the vessel to apply ultrasonic vibrations to the liquid within the vessel during a cleaning operation to generate cavitation bubbles in the liquid that remove debris from the surgical instrument.

17. The apparatus of claim 16, wherein the ultrasonic transducer is fixed to the vessel.

18. The apparatus of claim 17, wherein the ultrasonic transducer of the vessel is detachably attached to a power supply that is used to power an instrument ultrasonic transducer that powers the surgical instrument.

19. The apparatus of claim 17, wherein the ultrasonic transducer of the vessel is detachably coupleable to a main power supply.

20. The apparatus of claim 16, wherein the ultrasonic transducer coupled to the vessel is removably coupled to the vessel and is an instrument ultrasonic transducer that is disposed in a handpiece of an ultrasonic surgical instrument that is detachably coupleable to the handpiece.

21. The apparatus of claim 16, further comprising a heating element that heats the liquid within the vessel.

22. The apparatus of claim 21, further comprising a temperature sensor in the vessel that senses a temperature of the liquid in the vessel, and a control unit that controls the heating element based on the liquid temperature sensed by the temperature sensor.

23. The apparatus of claim 16, further comprising a seal member that seals the open end of the vessel.

24. The apparatus of claim 23, wherein the seal member includes an opening through which at least a portion of the surgical instrument is inserted in order to clean the surgical instrument, the seal member inhibiting the liquid from leaking from the vessel.

25. The apparatus of claim 16, wherein the vessel includes an insert that holds the liquid, and an outer portion that replaceably holds the insert.

26. The apparatus of claim 16, further comprising a plurality of bristles provided on an internal surface of the vessel.

27. The apparatus of claim 16, further comprising at least one energy director provided on an internal surface of the vessel.

28. A surgical instrument cleaning apparatus comprising:
a liquid-proof vessel configured to hold a liquid while receiving at least a portion of a surgical instrument that is to be cleaned, the vessel including an open end through which the surgical instrument is inserted into the liquid in the vessel, the vessel having a length extending in a first direction that intersects the open end and that is parallel to an insertion direction by which the surgical instrument is inserted into the vessel through the open end, the vessel having a width extending in a second direction perpendicular to the first direction, the length being substantially greater than the width; and
an ultrasonic transducer coupled to the vessel to apply ultrasonic vibrations to the liquid within the vessel during a cleaning operation to generate cavitation bubbles in the liquid that remove debris from the surgical instrument.

29. The apparatus of claim 28, wherein the ultrasonic transducer is fixed to the vessel.

30. The apparatus of claim 29, wherein the ultrasonic transducer of the vessel is detachably attached to a power supply that is used to power an instrument ultrasonic transducer that powers the surgical instrument.

31. The apparatus of claim 29, wherein the ultrasonic transducer of the vessel is detachably coupleable to a main power supply.

32. The apparatus of claim 28, wherein the ultrasonic transducer coupled to the vessel is removably coupled to the vessel and is an instrument ultrasonic transducer that is disposed in a handpiece of an ultrasonic surgical instrument that is detachably coupleable to the handpiece.

33. The apparatus of claim 28, further comprising a heating element that heats the liquid within the vessel.

34. The apparatus of claim 33, further comprising a temperature sensor in the vessel that senses a temperature of the liquid in the vessel, and a control unit that controls the heating element based on the liquid temperature sensed by the temperature sensor.

35. The apparatus of claim 28, further comprising a seal member that seals the open end of the vessel.

36. The apparatus of claim 35, wherein the seal member includes an opening through which at least a portion of the surgical instrument is inserted in order to clean the surgical instrument, the seal member inhibiting the liquid from leaking from the vessel.

37. The apparatus of claim 28, wherein the vessel includes an insert that holds the liquid, and an outer portion that replaceably holds the insert.

38. The apparatus of claim 28, further comprising a plurality of bristles provided on an internal surface of the vessel.

39. The apparatus of claim 28, further comprising at least one energy director provided on an internal surface of the vessel.
